(19) United States
(12) Patent Application Publication
(10) Pub. No.: US 2010/0119757 A1
(43) Pub. Date: May 13, 2010

(54) HEAT-PEELABLE DOUBLE-SIDED PRESSURE-SENSITIVE ADHESIVE SHEET

(75) Inventors: Daisuke Shimokawa, Osaka (JP); Yukio Arimitsu, Osaka (JP)

Correspondence Address: EDWARDS ANGELL PALMER & DODGE LLP, P.O. BOX 55874, BOSTON, MA, 02205, US

(73) Assignee: NITTO DENKO CORPORATION, Ibaraki-shi, Osaka (JP)

(21) Appl. No.: 12/450,917

(22) PCT Filed: Apr. 15, 2008
(86) PCT No.: PCT/JP2008/057363

§ 371 Date: Oct. 19, 2009

(30) Foreign Application Priority Data
Apr. 20, 2007 (JP) 2007-111391

(51) Int. Cl. B32B 7/06; C09J 7/00; B32B 7/04

(52) U.S. Cl. 428/40.2; 156/250

(57) ABSTRACT

Provided is a heat-peelable double-sided pressure-sensitive adhesive sheet that is advantageously usable in the step of cutting a multilayer ceramic sheet performed in a high-temperature atmosphere. Also provided is a process for the cutting of a multilayer ceramic sheet using the above-mentioned sheet.

The heat-peelable double-sided pressure-sensitive adhesive sheet includes a substrate; arranged on one side thereof, a heat-expandable pressure-sensitive adhesive layer containing heat-expandable microspheres; and arranged on the other side, a temporary-fixing pressure-sensitive adhesive layer containing a lipophilic layered clay mineral. The lipophilic layered clay mineral is preferably a layered silicate. The lipophilic layered clay mineral may be present in an amount of 0.1 to 45 parts by weight per 100 parts by weight of a base polymer of a pressure-sensitive adhesive constituting the temporary-fixing pressure-sensitive adhesive layer.

### TECHNICAL FIELD

The present invention relates to a heat-peelable double-sided pressure-sensitive adhesive sheet that is advantageously usable as a pressure-sensitive adhesive sheet for processing electronic components and is especially usable as a pressure-sensitive adhesive sheet for processing in cutting step of multilayer ceramic sheets. It also relates to a process for the cutting of a multilayer ceramic sheet using the heat-peelable double-sided pressure-sensitive adhesive sheet.

### BACKGROUND ART

Miniaturization and higher precision have been recently required of electronic components. Typically, ceramic capacitors, ceramic resistors, and ceramic inductors, as ones of ceramic electronic components, have been miniaturized to have smaller sizes represented by “0603” and “0402” sizes. They have also had larger capacities by piling up several hundreds or more of layers. Among such ceramic electronic components, ceramic capacitors require high processing accuracy in their production steps, so as to be miniaturized and to have higher precision (overall accuracy).

Exemplary production steps of ceramic capacitors include (1) a step of printing electrodes on a green sheet, (2) a laminating step, (3) a high-pressure pressing step, (4) a cutting step, and (5) a firing step. The laminating step (2) and the high-pressure pressing step (3) are often repeated two or more times according to the purpose. Each step requires accuracies. For example, the step (1) typically requires accuracy in electrode printing; the step (2) typically requires accuracy of position of electrodes; the step (3) requires accuracy in prevention of misregistration of electrodes, which misregistration is caused by deformation of green sheets due to pressurization; and the step (4) typically requires accuracy of cutting. If even one of these accuracies required in the steps is low, rejects are included in products, and this lowers the productivity.

Among these steps, the cutting step (4) often employs techniques using heat-peelable pressure-sensitive adhesive sheets (for example, Patent Document 1). Such heat-peelable double-sided pressure-sensitive adhesive sheets enable secure fixing of workpieces during cutting, and, once the cutting step is completed, they can lose their adhesive strength through heating and can thereby be easily removed from the workpieces. Additionally, a double-sided pressure-sensitive adhesive sheet may be employed as a pressure-sensitive adhesive sheet for processing in the cutting step, and the cutting of workpieces may be performed while fixing the workpieces to a mount through the double-sided pressure-sensitive adhesive sheet, so that the workpieces can be transported more satisfactorily and the processing can be performed with higher accuracy. The double-sided pressure-sensitive adhesive sheet includes a substrate; a heat-peelable pressure-sensitive adhesive layer arranged on one side of the substrate; and a temporary-fixing pressure-sensitive adhesive layer arranged on the other side of the substrate. For the purpose of improving the cutting accuracy, such cutting operation, especially through force-cutting, has been frequently performed in a high-temperature atmosphere so as to soften material green sheets. However, known heat-peelable pressure-sensitive adhesive sheets in this procedure suffer from pop-off (lifting) from the mount during the cutting step and thereby suffer from insufficient cutting accuracy, because they show reduced adhesive strength in such a high-temperature atmosphere. In particular, their pressure-sensitive adhesive layer facing the mount shows reduced adhesive strength.

### Patent Document 1: Japanese Unexamined Patent Application Publication (JP-A) No. 2004-300231

### DISCLOSURE OF INVENTION

### Problems to be Solved by the Invention

An object of the present invention is to provide a heat-peelable double-sided pressure-sensitive adhesive sheet that can be suitably used in the step of cutting a multilayer ceramic sheet in a high-temperature atmosphere. Specifically, the object is to provide such a heat-peelable double-sided pressure-sensitive adhesive sheet as follows. The heat-peelable double-sided pressure-sensitive adhesive sheet includes a substrate, a heat-expandable pressure-sensitive adhesive layer arranged on one side of the substrate, and a temporary-fixing pressure-sensitive adhesive layer arrange on the other side, in which the heat-expandable pressure-sensitive adhesive layer excels in adhesive strength even in a high-temperature atmosphere, thereby firmly adheres to the multilayer ceramic sheet before, during, and after cutting, but immediately loses or reduces its adhesive strength upon a heating-peeling treatment; and the temporary-fixing pressure-sensitive adhesive layer firmly adheres to the surface of the mount with satisfactory adhesive strength without causing problems such as pop-off even in a high-temperature atmosphere and, once an aimed bonding operation is accomplished, can be satisfactorily removed from the mount.

Another object of the present invention is to provide a process for the cutting of a multilayer ceramic sheet, which process enables cutting with high accuracy in a high-temperature atmosphere.

### Means for Solving the Problems

After intensive investigations to achieve the objects, the present inventors have found that the objects can be achieved by a heat-peelable pressure-sensitive adhesive sheet which includes a substrate, a heat-expandable pressure-sensitive adhesive layer arranged on or above one side of the substrate and containing heat-expandable microspheres, and a pressure-sensitive adhesive layer arranged on or above the other side and containing a lipophilic layered clay mineral. The present invention has been made based on these findings.

Specifically, the present invention provides, in an embodiment, a heat-peelable double-sided pressure-sensitive adhesive sheet which includes a substrate; a heat-expandable pressure-sensitive adhesive layer arranged on or above one side of the substrate; and a temporary-fixing pressure-sensitive adhesive layer arranged on or above the other side of the substrate, in which the heat-expandable pressure-sensitive adhesive layer contains heat-expandable microspheres, and the temporary-fixing pressure-sensitive adhesive layer contains a lipophilic layered clay mineral.

The content of the lipophilic layered clay mineral is preferably from 0.1 to 45 parts by weight per 100 parts by weight of a base polymer of a pressure-sensitive adhesive constituting the temporary-fixing pressure-sensitive adhesive layer. A layered silicate is preferably used as the lipophilic layered clay mineral.

In another embodiment, the present invention provides a process for cutting a multilayer ceramic sheet. The process includes the steps of affixing the multilayer ceramic sheet to the heat-expandable pressure-sensitive adhesive layer of the heat-peelable double-sided pressure-sensitive adhesive sheet which includes a substrate, a heat-expandable pressure-sensitive adhesive layer arranged on or above one side of the substrate and containing heat-expandable microspheres, and a pressure-sensitive adhesive layer arranged on or above the other side and containing a lipophilic layered clay mineral; affixing the temporary-fixing pressure-sensitive adhesive layer of the heat-peelable double-sided pressure-sensitive adhesive sheet to a mount to thereby fix the multilayer ceramic sheet onto the mount; and cutting the fixed multilayer ceramic sheet.

### ADVANTAGES

In the heat-peelable double-sided pressure-sensitive adhesive sheet according to the present invention, the temporary-fixing pressure-sensitive adhesive layer contains a lipophilic layered clay mineral, thereby shows higher cohesive strength and higher tackiness to an adherend in a high-temperature atmosphere, and advantageously prevents pop-off from the adherend (mount) in a force-cutting step performed in a high-temperature atmosphere. The temporary-fixing pressure-sensitive adhesive layer maintains an adequate adhesive strength without increasing even after subjected to a working in a high-temperature atmosphere and, once an aimed bonding operation is accomplished, can be easily and satisfactorily removed from the adherend (mount). Independently, the heat-expandable pressure-sensitive adhesive layer maintains a satisfactory adhesive strength even in a high-temperature atmosphere and can be immediately removed (peeled off) from the adherend, such as a multilayer ceramic sheet, upon a heating-peeling treatment.

Accordingly, when used in a step of force-cutting (pressing and cutting) a multilayer ceramic sheet performed in a high-temperature atmosphere, the heat-peelable double-sided pressure-sensitive adhesive sheet according to the present invention enables cutting with high accuracy, because it enables secure fixing between the multilayer ceramic sheet and mount without causing problems such as displacement and pop-off. After the completion of operation, the cut multilayer ceramic sheet can be easily removed from the surface of the heat-expandable pressure-sensitive adhesive layer of the heat-peelable double-sided pressure-sensitive adhesive sheet through a heating-peeling treatment, without applying a stress on the cut multilayer ceramic sheet. Additionally, the mount can be easily removed from the temporary-fixing pressure-sensitive adhesive layer of the heat-peelable double-sided pressure-sensitive adhesive sheet without suffering from adhesive transfer.

### BRIEF DESCRIPTION OF DRAWINGS

FIG. 1 is a schematic cross-sectional view showing a heat-peelable pressure-sensitive adhesive sheet according to an embodiment of the present invention.

FIG. 2 is a schematic cross-sectional view illustrating a process for the cutting of a multilayer ceramic sheet, according to an embodiment of the present invention.

### REFERENCE NUMERALS

1 substrate
2 rubber-like organic elastic layer
3 heat-expandable pressure-sensitive adhesive layer
4 separator
5 temporary-fixing pressure-sensitive adhesive layer
6 heat-peelable double-sided pressure-sensitive adhesive sheet according to the present invention
7 mount
8 multilayer ceramic sheet
9 force-cutting blade

### BEST MODES FOR CARRYING OUT THE INVENTION

### Heat-Peelable Double-Sided Pressure-Sensitive Adhesive Sheet

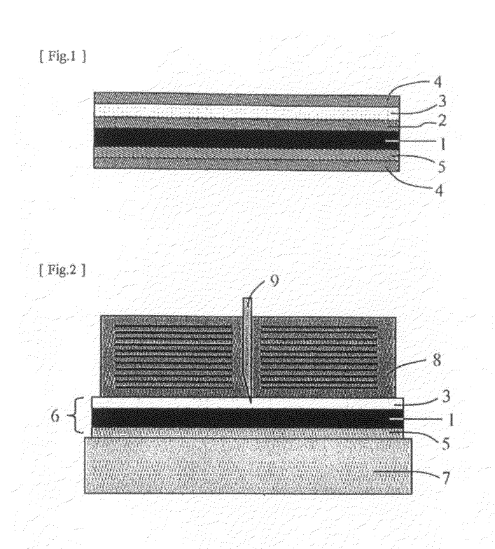

The configuration of a heat-peelable double-sided pressure-sensitive adhesive sheet according to an embodiment of the present invention will be illustrated with reference to the attached drawings. FIG. 1 is a schematic cross-sectional view showing an example of a heat-peelable double-sided pressure-sensitive adhesive sheet according to an embodiment of the present invention. In FIG. 1, the reference numerals “1” stands for a substrate, “2” stands for a rubber-like organic elastic layer, “3” stands for a heat-expandable pressure-sensitive adhesive layer, “4” stands for a separator, and “5” stands for a temporary-fixing pressure-sensitive adhesive layer (pressure-sensitive adhesive layer for temporary fixation), respectively. The rubber-like organic elastic layer 2 and separator 4 are provided according to necessity, and they are not necessarily provided. [Substrate]

The substrate 1 plays a role as a support (backing) or base of the heat-peelable double-sided pressure-sensitive adhesive sheet and can be any of suitable thin materials without limitation. Examples of such thin materials include paper, cloths, nonwoven fabrics, metallic foil, and laminates of them with a plastic, as well as laminates of plastics. Though not critical, the thickness of the substrate 1 is generally from about 5 to about 250 μm.

### [Rubber-Like Organic Elastic Layer]

The rubber-like organic elastic layer 2 is often provided between the substrate and the heat-expandable pressure-sensitive adhesive layer 3 and works as follows. Specifically, this layer helps the adhesive face of the heat-expandable pressure-sensitive adhesive layer 3 of the heat-peelable double-sided pressure-sensitive adhesive sheet to satisfactorily follow the surface dimensions of the adherend to thereby increase an adhesion area between them. Additionally, when the heat-expandable pressure-sensitive adhesive layer is heated to allow the after-mentioned heat-expandable microspheres to expand to thereby remove the layer from the adherend, the rubber-like organic elastic layer helps the heat-expandable pressure-sensitive adhesive layer through heating to expand in an accurate manner and thereby allows the heat-expandable pressure-sensitive adhesive layer to expand uniformly and preferentially in a thickness direction. The rubber-like organic elastic layer 2 may be arranged between the substrate 1 and the temporary-fixing pressure-sensitive adhesive layer 5.

For satisfactorily exhibiting the above functions, the rubber-like organic elastic layer 2 is preferably made from any of natural rubbers, synthetic rubbers, and synthetic resins having rubber elasticity, each having a Type D Shore D hardness of 50 or less, and especially preferably 40 or less, as determined according to the American Society for Testing and Materials (ASTM) D-2240 standard.

Examples of the synthetic rubbers and synthetic resins having rubber elasticity include nitrile rubbers, diene rubbers, acrylic rubbers, and other synthetic rubbers; polyolefins, polyesters, and other thermoplastic elastomers; and ethylene-vinyl acetate copolymers, polyurethanes, polybutadienes, flexible polyvinyl chloride)s, and other synthetic resins having rubber elasticity. Even inherently hard or rigid polymers, such as poly(vinyl chloride)s, can develop rubber elasticity by suitably combining with compounding agents such as plasticizers and flexibilizers to give a composition. The resulting composition is also usable as a material for constituting the rubber-like organic elastic layer 2. The rubber-like organic elastic layer 2 is also preferably made from any of polymers exemplified as a base polymer of a pressure-sensitive adhesive constituting the heat-expandable pressure-sensitive adhesive layer 3 as mentioned later, of which acrylic copolymers are more preferably used in the rubber-like organic elastic layer 2.

The way to provide the rubber-like organic elastic layer 2 is not especially limited and can be suitably chosen from among techniques such as a technique of applying a coating composition containing the materials for constituting the rubber-like organic elastic layer 2 to the substrate 1 (coating technique); a technique of bonding the substrate 1 with a film composed of the materials constituting the rubber-like organic elastic layer 2 or bonding the substrate 1 with a laminate film which includes the heat-expandable pressure-sensitive adhesive layer 3 and, arranged thereon, a layer composed of the materials constituting the rubber-like organic elastic layer 2 (dry lamination technique); and a technique of coextruding materials constituting the substrate 1 and materials constituting the rubber-like organic elastic layer 2 (coextrusion technique).

The rubber-like organic elastic layer 2 may be made from a pressure-sensitive adhesive material having tackiness and may be made typically from a foam film having a bubble (cell) structure. The way to introduce such a bubble structure into the rubber-like organic elastic layer 2 is not especially limited and can be chosen from among common techniques. Exemplary techniques include a technique of incorporating bubbles into the material through mechanical stirring; a technique of using a blowing agent; a technique of forming the rubber-like organic elastic layer 2 while dispersing therein particles made from a solvent-soluble material, and dissolving the particles in the solvent to remove them from the layer; a spraying technique; a technique of forming a syntactic foam; and a sintering technique. The rubber-like organic elastic layer 2 may include a single layer or two or more layers.

### [Heat-Expandable Pressure-Sensitive Adhesive Layer]

The heat-expandable pressure-sensitive adhesive layer 3 is a pressure-sensitive adhesive layer containing dispersed heat-expandable microspheres (microcapsules) that will expand by the action of heat. Specifically, the heat-expandable pressure-sensitive adhesive layer 3 can be made from a pressure-sensitive adhesive composition containing at least a pressure-sensitive adhesive (self-adhesive) for imparting tackiness, and heat-expandable microspheres (microcapsules) for imparting heat expandability. After the pressure-sensitive adhesive sheet is affixed to an adherend, the heat-expandable pressure-sensitive adhesive layer 3 can be easily removed from the adherend at an arbitrary time by heating the heat-expandable pressure-sensitive adhesive layer 3 so as to allow the heat-expandable microspheres to expand and/or swell to thereby reduce the adhesion area between the heat-expandable pressure-sensitive adhesive layer 3 and the adherend. It should be noted that a blowing agent that is not encapsulated does not stably develop satisfactory peelability.

### (Pressure-Sensitive Adhesive)

Pressure-sensitive adhesives which least restrict the expansion and/or swelling of the heat-expandable microspheres upon heating are usable as a pressure-sensitive adhesive in the heat-expandable pressure-sensitive adhesive layer 3. Exemplary pressure-sensitive adhesives for use herein include known pressure-sensitive adhesives such as rubber pressure-sensitive adhesives, acrylic pressure-sensitive adhesive, vinyl alkyl ether pressure-sensitive adhesives, silicone pressure-sensitive adhesives, polyester pressure-sensitive adhesives, polyamide pressure-sensitive adhesives, urethane pressure-sensitive adhesives, styrene-diene block copolymer pressure-sensitive adhesives, and pressure-sensitive adhesives having improved creep properties which are prepared by incorporating a hot-melt resin having a melting point of 200° C. or lower into these pressure-sensitive adhesives. Such pressure-sensitive adhesives can be used alone or in combination (see, for example, Japanese Unexamined Patent Application Publication (JP-A) No. S56-61468, JP-A No. S61-174857, JP-A No. S 63-17981, and JP-A No. S56-13040). The pressure-sensitive adhesive may further contain suitable additives in addition to polymer components of pressure-sensitive adhesive components (e.g., base polymer). Exemplary additives include crosslinking agents such as rosin derivative resins, polyterpene resins, petroleum resins, and oil-soluble phenol resins; plasticizers; fillers; and age inhibitors. The pressure-sensitive adhesive can be a pressure-sensitive adhesive of any form, such as emulsion type pressure-sensitive adhesive or solvent type pressure-sensitive adhesive.

Exemplary pressure-sensitive adhesives generally used as the pressure-sensitive adhesive include rubber pressure-sensitive adhesives containing a natural rubber or a variety of synthetic rubbers as a base polymer; and acrylic pressure-sensitive adhesives containing an acrylic polymer (homopolymer or copolymer) as a base polymer. The acrylic polymer uses one or more monomer components chosen typically from alkyl esters of (meth)acrylic acids such as methyl ester, ethyl ester, propyl ester, isopropyl ester, butyl ester, isobutyl ester, s-butyl ester, t-butyl ester, pentyl ester, hexyl ester, heptyl ester, octyl ester, 2-ethylhexyl ester, isooctyl ester, isodecyl ester, dodecyl ester, tridecyl ester, pentadecyl ester, hexadecyl ester, heptadecyl ester, octadecyl ester, nonadecyl ester, eicosyl ester, and other alkyl esters of (meth)acrylic acids whose alkyl moiety having 1 to 20 carbon atoms.

Where necessary, the acrylic polymer may further contain one or more units corresponding to other monomer components copolymerizable with the alkyl ester of (meth)acrylic acids, for the purpose of improving or modifying properties such as cohesive strength, thermal stability, and cross-linking properties. Exemplary monomer components herein include carboxyl-containing monomers such as acrylic acid, methacrylic acid, carboxyethyl acrylate, carboxypentyl acrylate, itaconic acid, maleic acid, fumaric acid, and crotonic acid; acid anhydride monomers such as maleic anhydride and itaconic anhydride; hydroxyl-containing monomers such as hydroxyethyl (meth)acrylates, hydroxypropyl (meth)acrylates, hydroxybutyl (meth)acrylates, hydroxyhexyl (meth)acrylates, hydroxyoctyl (meth)acrylates, hydroxydecyl (meth)acrylates, hydroxylauryl (meth)acrylates, and (4-hydroxymethylcyclohexyl)methyl (meth)acrylates; sulfo-containing monomers such as styrenesulfonic acid, allylsulfonic acid, 2-(meth)acrylamido-2-methylpropanesulfonic acid, (meth) acrylamidopropanesulfonic acid, sulfopropyl (meth)acrylates, and (meth) acryloyloxynaphthalenesulfonic acids; (meth)acrylamides and (N-substituted)amide monomers such as N,N-dimethyl(meth)acrylamides, N-butyl(meth)acrylamides, N-methylol(meth)acrylamides, and N-methylolpropane(meth)acrylamides; alkylamino (meth)acrylate monomers such as aminoethyl (meth)acrylates, aminoethyl (meth)acrylates, N,N-dimethylaminoethyl (meth)acrylates, and t-butylaminoethyl (meth)acrylates; alkoxyalkyl (meth)acrylate monomers such as methoxyethyl (meth)acrylates and ethoxyethyl (meth)acrylates; maleimide monomers such as N-cyclohexylmaleimide, N-isopropylmaleimide, N-laurylmaleimide, and N-phenylmaleimide; itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide; succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide; vinyl monomers such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxamides, styrene, α-methylstyrene, and N-vinylcaprolactam; cyanoacrylate monomers such as acrylonitrile and methacrylonitrile; epoxy-containing acrylic monomers such as glycidyl (meth)acrylates; glycol acrylic ester monomers such as polyethylene glycol (meth)acrylates, polypropylene glycol (meth)acrylates, methoxyethylene glycol (meth)acrylates, and methoxypolypropylene glycol (meth)acrylates; acrylic ester monomers each having a heterocycle, a halogen atom, or a silicon atom, such as tetrahydrofurfuryl (meth)acrylates, fluorinated (meth)acrylates, and silicone (meth)acrylates; multifunctional monomers such as hexanediol di(meth)acrylates, (poly)ethylene glycol di(meth)acrylates, (poly)propylene glycol di(meth)acrylates, neopentyl glycol di(meth)acrylates, pentaerythritol di(meth)acrylates, trimethylolpropane tri(meth)acrylates, pentaerythritol tri(meth)acrylates, dipentaerythritol hexa(meth)acrylates, epoxy acrylates, polyester acrylates, and urethane acrylates; olefinic monomers such as isoprene, butadiene, and isobutylene; and vinyl ether monomers such as vinyl ethers. Each of different copolymerizable monomers can be used alone or in combination.

More preferred pressure-sensitive adhesives for use in the heat-expandable pressure-sensitive adhesive layer 3 are pressure-sensitive adhesives using, as base polymers, polymers each having a dynamic elastic modulus of 5×10⁴ to 1000×10⁴ dyn/cm² (0.5 to 100 Pa) at temperatures ranging from ordinary temperature to 150° C. These pressure-sensitive adhesives are preferred in balance between the adequate adhesive strength before a heating treatment and the reduced adhesive strength after the heating treatment.

### (Heat-Expandable Microspheres)

The heat-expandable microspheres may be, for example, microspheres each composed of an elastic shell and, contained therein, a material that can easily gasify and expand by heating, such as isobutane, propane, or pentane. The shell is often made of a hot-melt (thermofusible) material or a material that breaks as a result of heat expansion. Exemplary materials for constituting the shell include vinylidene chloride-acrylonitrile copolymers, poly(vinyl alcohol)s, poly(vinyl butyral)s, poly(methyl methacrylate) s, polyacrylonitriles, poly(vinylidene chloride)s, and polysulfones. The heat-expandable microspheres can be prepared according to a common technique such as coacervation technique or interfacial polymerization technique. The heat-expandable microspheres are also commercially available typically as “Matsumoto Microsphere” [trade name, supplied by Matsumoto Yushi-Seiyaku Co., Ltd.].

The particle diameter (average particle diameter) of the heat-expandable microspheres is not especially limited and can be chosen suitably according typically to the thickness of the heat-expandable pressure-sensitive adhesive layer 3. The thickness can be chosen within ranges of, for example, from 5 to 120 μm, and preferably from 10 to 75 μm.

The heat-expandable microspheres preferably has an adequate strength so that they do not break until the ratio of cubic expansion reaches preferably 5 times or more, more preferably 7 times or more, and especially preferably 10 times or more. Such heat-expandable microspheres help the heat-expandable pressure-sensitive adhesive layer 3 to reduce its adhesive strength efficiently through a heating treatment.

The amount of the heat-expandable microspheres can be suitably set according typically to the intended ratio of expansion and intended degree of reduction in adhesive strength of the heat-expandable pressure-sensitive adhesive layer 3. In general, the amount is, for example, from 1 to 150 parts by weight, preferably from 10 to 130 parts by weight, and more preferably from 25 to 100 parts by weight, per 100 parts by weight of the base polymer of the pressure-sensitive adhesive constituting the heat-expandable pressure-sensitive adhesive layer 3. Heat-expandable microspheres, if present in an excessively large amount, may be liable to cause the cohesive failure of the pressure-sensitive adhesive in the heat-expandable pressure-sensitive adhesive layer 3; and, if present in an excessively small amount, may not provide sufficient peelability.

The heat-expandable pressure-sensitive adhesive layer 3 can be formed according to a common technique. Exemplary techniques include a technique of mixing heat-expandable microspheres, a pressure-sensitive adhesive, and, where necessary, solvents and other additives to give a coating composition, and applying the coating composition to the substrate 1 or to the rubber-like organic elastic layer 2; and a technique of applying the coating composition to the separator 4 or another suitable release paper, for example, to form a heat-expandable pressure-sensitive adhesive layer 3, and transferring the layer 3 to the substrate 1 or to the rubber-like organic elastic layer 2. The heat-expandable pressure-sensitive adhesive layer 3 may include a single layer or two or more layers.

The thickness of the heat-expandable pressure-sensitive adhesive layer 3 can be chosen according typically to how much degree the adhesive strength be reduced and is, for example, about 300 μm or less, and preferably from about 10 to about 150 μm. The heat-expandable pressure-sensitive adhesive layer 3, if having an excessively large thickness, may be liable to suffer from cohesive failure when the layer is removed after the heating treatment. In contrast, the heat-expandable pressure-sensitive adhesive layer 3, if having an excessively small thickness, may not sufficiently deform through the heating treatment and may not have a smoothly decreasing adhesive strength. In addition, the heat-expandable microspheres to be incorporated therein should have an excessively small particle diameter in this case.

The heat-expandable pressure-sensitive adhesive layer 3 of the heat-peelable double-sided pressure-sensitive adhesive sheet can be easily peeled off from the adherend through a heating treatment. Conditions for the heating treatment may be set according typically to how the adhesion area decreases depending typically on the surface condition of the adherend and the type of the heat-expandable microspheres; the thermal stability of the substrate 1 and adherend; and the way to carry out the heating. In general, the heating is carried out at a temperature of from 100° C. to 250° C., for a duration of 1 to 90 seconds typically using a hot plate, or for a duration of 5 to 15 minutes typically using a hot air dryer (air-forced oven). [Pressure-Sensitive Adhesive Layer For Temporary Fixing]

The temporary-fixing pressure-sensitive adhesive layer 5 is made from a pressure-sensitive adhesive composition containing at least a lipophilic layered clay mineral and a pressure-sensitive adhesive (tacky adhesive) for imparting tackiness. The pressure-sensitive adhesive constituting the temporary-fixing pressure-sensitive adhesive layer 5 can be one similar to the above-mentioned pressure-sensitive adhesive constituting the heat-expandable pressure-sensitive adhesive layer 3. The pressure-sensitive adhesive herein can also be a pressure-sensitive adhesive containing, as a base polymer, any of the natural rubbers, synthetic rubbers, and synthetic resins having rubber elasticity, exemplified as materials constituting the rubber-like organic elastic layer 2. The pressure-sensitive adhesive for use in the temporary-fixing pressure-sensitive adhesive layer 5 is preferably an acrylic pressure-sensitive adhesive containing an alkyl (meth)acrylate as a base polymer. The presence of a lipophilic layered clay mineral in the pressure-sensitive adhesive composition helps the temporary-fixing pressure-sensitive adhesive layer 5 to have higher cohesive strength and higher tackiness to the adherend in a high-temperature atmosphere.

### (Lipophilic Layered Clay Mineral)

As used herein a “lipophilic layered clay mineral” refers to a clay mineral having a crystal structure formed mainly by a stack of clay layers each having a two-dimensional structure. The lipophilic layered clay mineral, when placed in a solvent, swells to broaden distances between respective layers. In addition, it can take ions and molecules in between the layers while maintaining the layered structure. A layered silicate can be preferably used as the lipophilic layered clay mineral, because such layered silicate satisfactorily disperses in a solvent and is easy to handle. Specific examples of lipophilic layered clay minerals include smectite, saponite, sauconite, stevensite, hectorite, margarite, talc, phlogopite, chrysotile, chlorite, vermiculite, kaolinite, muscovite, xanthophyllite, dickite, nacrite, pyrophillite, montmorillonite, beidellite, nontronite, tetrasilicic mica, sodium teniolite, antigorite, and halloysite. The lipophilic layered clay mineral for use herein can be any of naturally-occurring or synthetic lipophilic layered clay minerals. The average length of particles constituting the lipophilic layered clay mineral advantageously usable herein is preferably from 0.01 to 100 μm, and especially preferably from 0.05 to 10 μm, and the aspect ratio thereof is preferably from 20 to 500, and especially preferably from 50 to 200. Each of different lipophilic layered clay minerals can be chosen and used alone or in combination.

The amount of the lipophilic layered clay mineral(s) can be chosen within ranges of preferably from 0.1 to 45 parts by weight, more preferably from 1 to 40 parts by weight, and especially preferably from 10 to 30 parts by weight, per 100 parts by weight of the base polymer of the pressure-sensitive adhesive constituting the temporary-fixing pressure-sensitive adhesive layer. Lipophilic layered clay minerals, if present in an excessively small amount, may not effectively exhibit advantages such as improvements in cohesive strength and adhesive strength in a high-temperature atmosphere. In contrast, lipophilic layered clay minerals, if present in an excessively large amount, may cause problems in peeling after use or may be difficult to disperse uniformly in the pressure-sensitive adhesive, and this may impede practical production of the sheet.

Where necessary, the temporary-fixing pressure-sensitive adhesive layer 5 may further contain suitable additives in addition to the pressure-sensitive adhesive and lipophilic layered clay mineral. Exemplary additives include crosslinking agents (e.g., rosin derivative resins, polyterpene resins, petroleum resins, and oil-soluble phenolic resins); plasticizers; fillers; and age inhibitors.

The thickness of the temporary-fixing pressure-sensitive adhesive, layer 5 can be chosen within ranges of, for example, from 0.5 to 100 μm, and preferably from 2 to 50 μm. The temporary-fixing pressure-sensitive adhesive layer 5, if having an excessively small thickness, may not exhibit sufficient tackiness and may cause problems such as pop-off from an adherend (such as mount) when the layer 5 is affixed to the adherend. The temporary-fixing pressure-sensitive adhesive layer 5, if having an excessively large thickness, may deform excessively, and may cause lateral displacement and thereby adversely affect cutting accuracy when the sheet is used in a force-cutting step of a multilayer ceramic sheet performed in a high-temperature atmosphere.

### [Separator]

The separator 4 is a layer provided for the protection of the surface(s) of the heat-expandable pressure-sensitive adhesive layer 3 and/or temporary-fixing pressure-sensitive adhesive layer 5 and will be removed when the heat-expandable pressure-sensitive adhesive layer 3 and/or temporary-fixing pressure-sensitive adhesive layer 5 is affixed to an adherend. The separator 4 may be made typically of a suitable release paper. Specific examples of usable materials include base materials each having a release layer typically of a plastic film or paper whose surface has been treated with a releasing agent such as a silicone, long-chain alkyl, fluorine, or molybdenum sulfide releasing agent; low-adhesive base materials made from fluorocarbon polymers such as polytetrafluoroethylenes, polychlorotrifluoroethylenes, polyvinyl fluoride)s, poly(vinylidene fluoride)s, tetrafluoroethylene/hexafluoropropylene copolymers, and chlorofluoroethylene/vinylidene fluoride copolymers; and low-adhesive base materials made from nonpolar polymers such as olefinic resins (e.g., polyethylenes and polypropylenes). The separator 4 is a layer provided according to necessity and may not necessarily be provided.

### [Process for Cutting Multilayer Ceramic Sheet]

Though not especially limited in use, the heat-peelable double-sided pressure-sensitive adhesive sheets according to the present invention are usable as pressure-sensitive adhesive sheets for the temporary fixing, storage, or transportation of a variety of adherends. Among such uses, they are suitably usable as temporary fixing members in processing of electronic components and especially suitably usable as pressure-sensitive adhesive sheets for the fixation of multilayer ceramic sheets during force-cutting performed in a high-temperature atmosphere. A process for the cutting of a multilayer ceramic sheet, according to an embodiment of the present invention, will be illustrated below with reference to the drawings. FIG. 2 is a schematic cross-sectional view showing how the multilayer ceramic sheet is fixed to a mount (support) through a heat-peelable double-sided pressure-sensitive adhesive sheet according to the present invention, and a cutting blade bites into and thereby cuts the multilayer ceramic sheet. In FIG. 2, the reference numeral “6” stands for a heat-peelable double-sided pressure-sensitive adhesive sheet according to the present invention. The reference numerals “1”, “3”, and “5” in FIG. 2 are as with the reference numerals “1”, “3”, and “5” in FIG. 1. The reference numerals “7” stands for a mount, “8” stands for a multilayer ceramic sheet, and “9” stands for a force-cutting blade for cutting the multilayer ceramic sheet 8. The workpiece multilayer ceramic sheet 8 can be securely fixed through the heat-peelable double-sided pressure-sensitive adhesive sheet 6 by affixing the temporary-fixing pressure-sensitive adhesive layer to the mount and affixing the heat-expandable pressure-sensitive adhesive layer 3 to the multilayer ceramic sheet 8.

The step of cutting the multilayer ceramic sheet 8 is performed in a high-temperature atmosphere (for example, at a temperature of from 60° C. to 100° C.) in order to improve the cutting accuracy. It is important that the temperature during the cutting step be lower than the expansion starting temperature of the heat-expandable microspheres contained in the heat-expandable pressure-sensitive adhesive layer 3. The heat-peelable double-sided pressure-sensitive adhesive sheet 6 enables secure fixation of the multilayer ceramic sheet 8 before, during, and after the cutting step, because the two pressure-sensitive adhesive layers thereof, i.e., the heat-expandable pressure-sensitive adhesive layer 3 and temporary-fixing pressure-sensitive adhesive layer 5 excel in cohesive strength and adhesive strength in atmospheres of both ordinary temperature and high temperature. In particular, the sheet prevents the misregistration of the multilayer ceramic sheet 8 caused by insertion of the force-cutting blade 9 upon cutting and thereby enables accurate and precise cutting to give chip elements as a unit component, because the temporary-fixing pressure-sensitive adhesive layer 5 is resistant to pop-off and deformation even in a high-temperature atmosphere.

After the completion of cutting, the workpiece (cut multilayer ceramic sheet 8) can be detached from the mount 7 by heating the heat-expandable pressure-sensitive adhesive layer 3 to a temperature equal to or higher than the expansion temperature of the heat-expandable microspheres so that the heat-expandable pressure-sensitive adhesive layer 3 loses or reduces its adhesive strength. The heat-expandable pressure-sensitive adhesive layer 3 can be easily peeled off or removed from the adherend through the heating treatment. Conditions for the heating treatment may be set according typically to how the adhesion area decreases depending typically on the surface condition of the adherend and the type of the heat-expandable microspheres; the thermal stability of the substrate and adherend; and the way to carry out the heating. In general, the heating is carried out at a temperature of from 100° C. to 250° C., for a duration of 1 to 90 seconds typically using a hot plate, or for a duration of 5 to 15 minutes typically using a hot air dryer (air forced oven).

After recovering the cut multilayer ceramic sheet 8 according to a suitable procedure, the mount 7 can be removed, typically by peeling, from the temporary-fixing pressure-sensitive adhesive layer 5 of the heat-peelable double-sided pressure-sensitive adhesive sheet 6. The temporary-fixing pressure-sensitive adhesive layer of the heat-peelable double-sided pressure-sensitive adhesive sheet 6 can be removed or peeled satisfactorily even after undergoing working in a high-temperature atmosphere, because the layer contains a lipophilic layered clay mineral and thereby excels in cohesive strength.

### EXAMPLES

The present invention will be illustrated in further detail with reference to several examples below, which are, however, by no means construed to limit the scope of the present invention.

### Example 1

Pressure-Sensitive Adhesive Layer For Temporary Fixing In toluene were uniformly dissolved 100 parts by weight of an acrylic copolymer A, 1 part by weight of a montmorillonite (supplied by Kunimine Industries, Co., Ltd. under the trade name “Kunipia G”) as a lipophilic layered clay mineral, and 1.5 parts by weight of an isocyanate crosslinking agent to give a coating composition. The acrylic copolymer A was composed of 70 parts by weight of ethyl acrylate, 30 parts by weight of 2-ethylhexyl acrylate, 5 parts by weight of hydroxyethyl acrylate, and 5 parts by weight of methyl methacrylate. The coating composition was applied to a PET (poly(ethylene terephthalate) film) substrate 100 μm thick to form a temporary-fixing pressure-sensitive adhesive layer having a thickness after drying of 5 μm.

Rubber-Like Organic Elastic Layer

In toluene were dissolved 100 parts by weight of the acrylic copolymer A and 2 parts by weight of a polyurethane crosslinking agent (supplied by Nippon Polyurethane Industry Co., Ltd. under the trade name “CORONATE L”) to give a coating composition. The coating composition was applied to a side of the PET substrate opposite to the temporary-fixing pressure-sensitive adhesive layer, to form a rubber-like organic elastic layer having a thickness after drying of 15 μm.

Heat-Expandable Pressure-Sensitive Adhesive Layer

In toluene were uniformly dissolved 100 parts by weight of the acrylic copolymer A, 2 parts by weight of a polyurethane crosslinking agent (supplied by Nippon Polyurethane Industry Co., Ltd. under the trade name “CORONATE L”), 20 parts by weight of a terpene tackifier resin (supplied by Yasuhara Chemical Co., Ltd. under the trade name “YS Polyster T130”), and 40 parts by weight of heat-expandable microspheres. The coating composition was applied to a separator (poly(ethylene terephthalate) base material 38 μm thick) to form a heat-expandable pressure-sensitive adhesive layer having a thickness after drying of 35 μm.

Heat-Peelable Double-Sided Pressure-Sensitive Adhesive Sheet

The rubber-like organic elastic layer was affixed to the heat-expandable pressure-sensitive adhesive layer to give a heat-peelable double-sided pressure-sensitive adhesive sheet according to the present invention.

### Example 2

A heat-peelable double-sided pressure-sensitive adhesive sheet according to the present invention was prepared by the procedure of Example 1, except for using the lipophilic layered clay mineral in an amount of 10 parts by weight in the preparation of temporary-fixing pressure-sensitive adhesive layer.

### Example 3

A heat-peelable double-sided pressure-sensitive adhesive sheet according to the present invention was prepared by the procedure of Example 1, except for using the lipophilic layered clay mineral in an amount of 40 parts by weight in the preparation of temporary-fixing pressure-sensitive adhesive layer.

### Comparative Example 1

A heat-peelable double-sided pressure-sensitive adhesive sheet was prepared by the procedure of Example 1, except for using no lipophilic layered clay mineral in the preparation of temporary-fixing pressure-sensitive adhesive layer.

### Comparative Example 2

A heat-peelable double-sided pressure-sensitive adhesive sheet was prepared by the procedure of Example 1, except for using the lipophilic layered clay mineral in an amount of 50 parts by weight in the preparation of temporary-fixing pressure-sensitive adhesive layer.

### (Evaluations)

The heat-peelable double-sided pressure-sensitive adhesive sheets prepared according to the examples and comparative examples were evaluated as follows. The results are shown in Table 1.

Adhesive Strength at 100° C.

The heat-peelable double-sided pressure-sensitive adhesive sheets prepared in the examples and comparative examples were cut into tape-form samples 20 mm wide and 140 mm long. A PET (poly(ethylene terephthalate)) film 25 μm thick and 30 mm wide was used as an adherend. Each of the temporary-fixing pressure-sensitive adhesive layer of the samples was affixed to the adherend in accordance with Japanese Industrial Standards (JIS) Z 0237 under a normal condition, the resulting articles were each mounted to a tensile tester with a high-temperature chamber previously set at 100° C., left stand for 5 minutes, subjected to peeling at a peel speed of 300 mm/min and a peel angle of 180 degrees, and loads upon peeling were measured.

Pop-Off From Mount

The temporary-fixing pressure-sensitive adhesive layer of each of the heat-peelable double-sided pressure-sensitive adhesive sheets prepared in the examples and comparative examples was affixed to a mount made of BA304 stainless steel, left stand at a temperature of 100° C. for 30 minutes, and whether pop-off of the pressure-sensitive adhesive sheets occurred was visually observed. A sample showing no pop-off from the mount was evaluated as having “good” adhesive strength; whereas a sample showing pop-off from the mount was evaluated as having “poor” adhesive strength.

Peelability From Mount

After evaluation on the pop-off from the mount was performed, each of the pressure-sensitive adhesive sheets was peeled off from the mount, and peelability was evaluated. A sample that could be satisfactorily peeled off from the mount without causing problems such as adhesive transfer and cohesive failure was evaluated as having “good” peelability; whereas a sample that could not be peeled off or caused adhesive transfer to the adherend (mount) after peeling was evaluated as having “poor” peelability.

TABLE 1

| | Adhesive strength in | Pop-off | Peelability |
|---|---|---|---|
| | atmosphere of 100° C. | from | from |
| | (N/20 mm) | mount | mount |
| Example 1 | 0.5 | Good | Good |
| Example 2 | 3.5 | Good | Good |
| Example 3 | 7.9 | Good | Good |
| Comparative Example 1 | 0.02 | Poor | Good |
| Comparative Example 2 | 12.3 | Good | Poor |

The heat-peelable double-sided pressure-sensitive adhesive sheets according to the present invention excel in adhesive strength (N/20 mm) in an atmosphere of 100° C., free from pop-off of the tapes, and enable force cutting with high accuracy in the step of cutting a green sheet performed even in a high-temperature atmosphere. In contrast, the pressure-sensitive adhesive sheet according to Comparative Example 1 suffers from pop-off in an atmosphere of 100° C., thereby shows poor cutting accuracy in the cutting step performed in a high-temperature atmosphere; and the pressure-sensitive adhesive sheet according to Comparative Example 2 has poor peelability and is unsuitable for use in processing of electronic components, such as cutting of multilayer ceramic sheets.

### INDUSTRIAL APPLICABILITY

The heat-peelable double-sided pressure-sensitive adhesive sheets according to the present invention are advantageously usable in the step of force-cutting a multilayer ceramic sheet in a high-temperature atmosphere. The heat-peelable double-sided pressure-sensitive adhesive sheets, when used in the step of force-cutting a multilayer ceramic sheet in a high-temperature atmosphere, fix the multilayer ceramic sheet onto the mount without causing displacement and pop-off and thus enable cutting with high accuracy. After the completion of processing, the multilayer ceramic sheet can be easily detached from the surface of the heat-expandable pressure-sensitive adhesive layer of the heat-peelable double-sided pressure-sensitive adhesive sheets through a heating-peeling treatment without receiving stress thereon; and the mount can be easily peeled off from the temporary-fixing pressure-sensitive adhesive layer of the heat-peelable double-sided pressure-sensitive adhesive sheets without suffering from adhesive transfer.

1. A heat-peelable double-sided pressure-sensitive adhesive sheet comprising a substrate; a heat-expandable pressure-sensitive adhesive layer arranged on or above one side of the substrate; and a temporary-fixing pressure-sensitive adhesive layer arranged on or above the other side of the substrate, wherein the heat-expandable pressure-sensitive adhesive layer contains heat-expandable microspheres, and the temporary-fixing pressure-sensitive adhesive layer contains a lipophilic layered clay mineral, wherein the lipophilic layered clay mineral is present in a content of 0.1 to 45 parts by weight per 100 parts by weight of a base polymer of a pressure-sensitive adhesive constituting the temporary-fixing pressure-sensitive adhesive layer.

2. (canceled)

3. The heat-peelable double-sided pressure-sensitive adhesive sheet of claim 1, wherein the lipophilic layered clay mineral is a layered silicate.

4. A process for cutting a multilayer ceramic sheet, the process comprising the steps of affixing the multilayer ceramic sheet to the heat-expandable pressure-sensitive adhesive layer of the heat-peelable double-sided pressure-sensitive adhesive sheet of claim 1; affixing the temporary-fixing pressure-sensitive adhesive layer of the heat-peelable double-sided pressure-sensitive adhesive sheet to a mount to thereby fix the multilayer ceramic sheet onto the mount; and cutting the fixed multilayer ceramic sheet.

5. A process for cutting a multilayer ceramic sheet, the process comprising the steps of affixing the multilayer ceramic sheet to the heat-expandable pressure-sensitive adhesive layer of the heat-peelable double-sided pressure-sensitive adhesive sheet of claim 3; affixing the temporary-fixing pressure-sensitive adhesive layer of the heat-peelable double-sided pressure-sensitive adhesive sheet to a mount to thereby fix the multilayer ceramic sheet onto the mount; and cutting the fixed multilayer ceramic sheet.
